(19) United States
(12) Patent Application Publication
(10) Pub. No.: US 2013/0104038 A1
(43) Pub. Date: Apr. 25, 2013

(54) METHOD FOR AUTOMATIC URL SHORTENING

(71) Applicant: TinyURL, LLC, Blaine, MN (US)

(72) Inventors: David Zhi Galper, Brookline, MA (US); Siddhartha Goyal, Boston, MA (US); Kevin Gilbertson, Blaine, MN (US)

(73) Assignee: TINYURL, LLC, Blaine, MN (US)

(21) Appl. No.: 13/656,230

(22) Filed: Oct. 19, 2012

Related U.S. Application Data
(60) Provisional application No. 61/548,752, filed on Oct. 19, 2011.

(51) Int. Cl. G06F 17/27

(52) U.S. Cl. 715/271

(57) ABSTRACT

A method for automatically shortening one or more Uniform Resource Locators (URLs) via a plug-in or functionality embedded in an operating system. The method may allow a user to initiate a request to shorten the one or more URLs via a command without clicking on the plug-in. An event listener may be initiated to identify the one or more URLs present in a temporary storage location or passed as an argument to an application based on a protocol scheme. The browser plug-in may invoke a call to a first server for shortening the one or more URLs to one or more shortened URLs. Further, the method may replace the one or more URLs in the temporary storage location with the one or more shortened URLs and may return the one or more shortened URLs to the user or pass a shortened URL as an argument to an application upon the launch of the application.

### CROSS-REFERENCE TO RELATED APPLICATIONS

This application claims the benefit of the following provisional applications, each of which is hereby incorporated by reference in its entirety: U.S. Provisional Patent Application Ser. No. 61/548,752, filed Oct. 19, 2011.

### FIELD

This disclosure relates to Uniform Resource Locator (URL) shortening capabilities using a plug-in and specifically, embodiments are directed towards methods to shorten the URLs via copy and paste commands and methods to shorten URLs where URLs are passed from one application to another without the need to explicitly copy and paste those URLs.

### DESCRIPTION OF THE RELATED ART

An important use of computers is to transfer information among a plurality of users over a network. Information providers and users exchange content (e.g., web pages) over networked environments such as the Internet, which is a worldwide interconnection of millions of computing devices (from personal computers to servers to mobile devices). The web pages must have an address associated with them in a recognized format, i.e., a Uniform Resource Locator (URL), and links that specify the availability of a known resource and the address for accessing it. Internet users come across many web links while browsing and navigating computer networks and use different mechanisms to shorten the URL or link by reducing the number of characters in the original link to a smaller number of characters in the shortened link.

One such shortening mechanism is a website, where a user copies a URL and pastes the URL into a text area on the website and clicks a button on the website to shorten the URL so that it can be easily copied and pasted into other applications and websites. A drawback of this shortening mechanism is that the user has to visit the URL shortening website every time the user wishes to shorten a URL, which is a long and time consuming process. Another shortening mechanism by which URLs can be shortened is by using a web browser plug-in installed in a web browser which does not require the user to visit the URL shortening website. The user needs to install the web browser plug-in into the web browser and click on a plug-in icon in the web browser plug-in toolbar for automatically shortening the URL. After clicking on the plug-in icon, the user may receive a shortened URL that can be copied and then pasted to the user desired location. This shortened URL received from the web browser plug-in may be similar to a shortened URL received from the URL shortening website. The drawback of the web browser plug-in is that, every time the user wishes to shorten the URL, the user must physically click on the URL shortening icon in the browser plug-in toolbar to shorten the URL. Another shortening mechanism by which URLs can be shortened in a mobile environment is by launching a third party application to shorten a URL. A user must first copy the URL into a pasteboard buffer using the native OS copy command. Once this is done the user must then launch the 3rd party shortening application, and paste the URL to be shortened into a text field. Once that is done the user must click the shorten button to have the URL shortened. At this point the URL is then placed into the pasteboard and thus when the 3rd party application is launched the pasted URL is the shortened URL. The drawback to the third party application is that, every time the user wishes to shorten the URL, the user must manually launch the shortening application and copy and paste the URL into the application to shorten the URL.

Owing to these drawbacks, there is a need for URL shortening mechanisms capable of automatically shortening one or more URLs without requiring the user to visit a specific website, click on a URL shortening icon, or launch and paste a URL into a third party application in a mobile environment.

### SUMMARY OF THE INVENTION

The embodiments of the present invention provide URL shortening capabilities that may automatically shorten one or more URLs via copy and paste commands, without requiring users to click on a plug-in or launch and paste a URL into a third party application in a mobile environment.

In an embodiment, the present invention provides a method for automatically shortening one or more Uniform Resource Locators (URLs) using any domain via a plug-in or embedded functionality in an operating system. The method may include receiving a request to shorten the one or more URLs. The request may be made via a command initiated by a user, and the request may be received without clicking on a plug-in or launching a standalone third party shortening application. In an embodiment, the command may be a copy command initiated by the user. The copy command may be invoked via any copy action initiated by the user. In another embodiment, the command may be a paste command. The paste command may be invoked via any paste action initiated by the user. The method may also include receiving selected content at a temporary storage location upon initiation of the command. In response to receiving the command, the method may automatically invoke an event listener to parse the selected content stored at the temporary storage location 108. The event listener facilitates the identification of one or more URLs based on a protocol scheme. The method may also include passing a selected URL in a first application running on a mobile device as an argument to a second application running on a mobile device, which the second application running on a mobile device receives from the operating system after the selected URL has been shortened by the embedded functionality in the operating system.

Further, the method may invoke a call to a first server via the plug-in or embedded functionality in an operating system to shorten the one or more URLs upon identification. Optionally, the first server may send a request to a second server to affiliate the one or more URLs with one or more merchant sites upon determining that the affiliation code required for affiliating the one or more URLs with the one or more merchant sites is available. The request may be sent by the first server upon receiving the shorten request from the plug-in. The method may also allow the second server to convert the one or more URLs to the one or more affiliated URLs upon affiliation with the one or more merchant sites. Further, the second server may send the one or more shortened URLs to the first server. The first server may be configured to shorten the one or more affiliated URLs to the one or more shortened URLs. The first server may store the one or more URLs, the one or more affiliated URLs, and the one or more shortened URLs in a database. The method may return the one or more shortened URLs to the user.

In addition to the embodiment specified above, the method may further allow the one or more Internet users to click and access the one or more shortened URLs. Further, the first server may track the number of clicks to the one or more shortened URLs and may associate the number of clicks with a user account. Furthermore, the second server may include a tracking mechanism to track revenue generated by the one or more shortened URLs. The revenue may be generated upon the purchase of a product or service made through the one or more affiliated URLs. The method may then enable crediting a portion of the revenue to the user associated with the user account. The user described herein may be the user who has sent a request to shorten the one or more URLs. The portion of revenue may be calculated based on a set commission scheme.

### BRIEF DESCRIPTION OF THE FIGURES

Further objects, features, and advantages of the invention may become apparent from the following detailed description taken in conjunction with the accompanying drawings illustrating embodiments of the invention.

FIG. 1 illustrates an exemplary operating environment in which various embodiments can operate;

FIG. 2 illustrates a block diagram depicting a user device of FIG. 1;

FIG. 3A illustrates a sequence diagram depicting a URL shortening mechanism using a copy command according to an embodiment of the invention;

FIG. 3B illustrates a sequence diagram depicting a URL shortening mechanism using a plug-in and a paste command according to another embodiment of the invention;

FIG. 4 illustrates a flowchart depicting a method for automatically shortening one or more URLs via a plug-in according to embodiments of the invention;

FIG. 5 illustrates a flowchart depicting a method for affiliating the one or more URLs using a plug-in according to an embodiment of the invention; and

FIG. 6 illustrates a flowchart depicting a method of communication between users and server devices using a plug-in according to embodiments of the invention.

FIG. 7 illustrates a sequence diagram depicting a URL shortening mechanism using embedded functionality and a copy command according to an embodiment of the invention;

FIG. 8 illustrates a sequence diagram depicting a URL shortening mechanism using plug-in and a paste command according to another embodiment of the invention;

FIG. 9 illustrates a flowchart depicting a method for automatically shortening one or more URLs via embedded functionality according to embodiments of the invention;

FIG. 10 illustrates a flowchart depicting a method for affiliating the one or more URLs using embedded functionality according to an embodiment of the invention; and

FIG. 11 illustrates a flowchart depicting a method of communication between users and server devices using embedded functionality according to embodiments of the invention.

FIG. 12 illustrates a flowchart according to embodiments of the invention.

FIG. 13 illustrates a flowchart according to an exemplary and non-limiting embodiment.

### DETAILED DESCRIPTION OF THE PREFERRED EMBODIMENT(S)

In the following detailed description, reference is made to the accompanying drawings that form a part hereof and which is shown by way of illustrating specific embodiments in which the invention may be practiced. These embodiments, also referred to as “examples”, are described in detail to enable those skilled in the art to practice the invention, and it is to be understood that the embodiments may be combined or that other embodiments may be utilized and that structural, logical, and electrical changes may be made without deviating from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a “nonexclusive or” unless otherwise indicated. Furthermore, all publications, patents, and patent documents referred in this document are incorporated by reference herein in their entirety. In the event of inconsistent usages between this document and those documents so incorporated by reference, the usage in the incorporated reference(s) should be considered supplementary to that of this document; for irreconcilable inconsistencies, the usage in this document controls.

The present invention provides a URL shortening capability via a plug-in or embedded operating system functionality that does not require a user to click on an icon to shorten one or more URLs. However, the user will be able to use copy and paste commands and have the URL shortened automatically when the plug-in is installed or the embedded operating system functionality is enabled. The plug-in may allow the shortening of the one or more URLs using one or more domains. The user will also be able to launch an application that receives a shortened URL, as an argument from the operating system upon launch, that the operating system shortens if it detects that one of the application launch arguments is a URL that has not already been shortened.

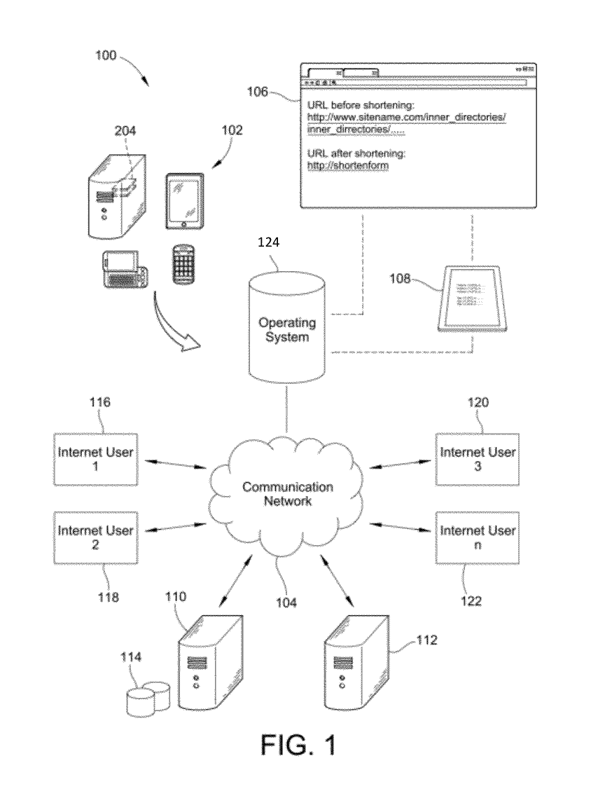

FIG. 1 illustrates a general exemplary environment 100, without limitation, in which various embodiments of the present invention may operate. The environment 100 may include a device 102 (hereinafter referred to as a user device 102). The user device 102 may be coupled to a communication network 104 such as the Internet to interact with a user. The user (as described herein) may be any person skilled in the art. An operating system 124 such as Windows, OSX, Linux, iOS, Android, and the like may be running on the user device. The operating system may include embedded functionality to shorten one or more URLs. The operating system may be coupled to temporary storage location 108 for receiving or providing selected content whenever any user initiates a command to copy or paste the selected content from or to the temporary storage location 108. The temporary storage location 108 may be a short-term data storage location such as a clipboard, a pasteboard, a cache memory, and the like, which may allow data transfer between host applications 106 via the copy and paste commands. A plurality of host applications 106 such as a word processor, an email application, a browser, other document processing applications, other messaging applications, social media applications, ecommerce applications and the like may be running in the user device 102. The host application 106 may further include a plug-in installed thereon to shorten one or more URLs. The plug-in described herein may be an add-on application, a standalone application, a helper application, and the like to communicate with the host application 106 of the user device 102 for shortening the one or more URLs. The host application 106 may include or be coupled to a temporary storage location 108 for receiving or providing selected content whenever any user initiates a command to copy or paste the selected content from or to the temporary storage location 108. The temporary storage location 108 may be a short-term data storage location such as a clipboard, a cache memory, and the like, which may allow data transfer between host applications 106 via the copy and paste commands.

Further, the embedded functionality or plug-in to shorten the one or more URL's may add an event listener to the temporary storage location 108 of the user device 102 when the host application 106 is active. The event listener may be used to detect the copy and paste commands initiated through the embedded functionality or host application 106 on the user device 102. Furthermore, selected content may be received by the temporary storage location 108 when the user initiates the copy or paste commands. Detailed functioning of these commands will be explained in the subsequent paragraphs of the specification.

The environment 100 may further include one or more servers for affiliating and shortening the one or more URLs. A first server 110 may be used to shorten the one or more URLs selected by the user to be shortened. The first server 110 may include a plurality of URL shortening Application Program Interfaces (APIs) that may shorten the one or more selected URLs using one or more domains.

Optionally, the first server 110 may send a request to a second server 112 for affiliating the one or more selected URLs with one or more merchant sites upon determining that the affiliation code required for affiliating the one or more URLs with one or more merchant sites is available, before shortening the one or more selected URLs. In embodiments, the second server 112 may be a third-party server, which may leverage a tracking mechanism for affiliating the one or more selected URLs with the one or more merchant sites. The second server 112 may be used to convert the one or more selected URLs into one or more affiliated URLs such that the second server 112 may track the revenue generated by the use of the one or more affiliated URLs. The one or more affiliated URLs may then be sent to the first server 110. The first server 110 may include URL shortening Application Program Interfaces (APIs) to shorten the one or more affiliated URLs using the one or more domains.

Alternatively, the first server 110 may store the one or more selected URLs, the one or more affiliated URLs, and the one or more shortened URLs in a database 114. The first server 110 may track the number of clicks made to the one or more shortened URLs and associate the clicks with a user account. The user device 102 may share the one or more shortened URLs with other Internet users 116-122. The Internet users 116-122 may click and access the one or more shortened URLs shared by the user device 102. The one or more shortened URLs may navigate the Internet user browser window to the merchant site where the Internet users may purchase at least a service or product. The second server 112 may generate revenue whenever the Internet users 116-122 purchase at least one product or service. A portion of the generated revenue may be shared with the user who shortened the one or more URLs.

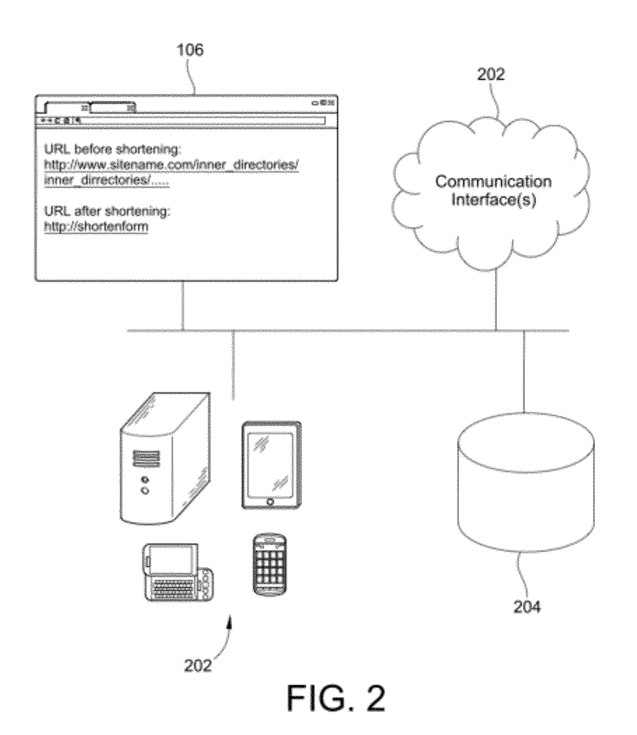

FIG. 2 illustrates a block diagram 200 depicting the user device 102. The user device 102 may include or may be coupled to a communication interface 202 among the hardware and software that provide the user the ability to transmit and receive data over the communication network 104. The communication network 104 may be a local area network, a wide area network, or combinations thereof, e.g., the Internet, and may provide communication between the user device 102 and other resources such as the first server 110 and the second server 112. The user device 102 may be a personal computer, a portable device such as a tablet computer, a smart phone, or any operating system-based portable device. The user device 102 may be of the type that is well known to those skilled in the art and may include persistent storage 204 such as a hard disk, a memory card, and the like. Further, the user device 102 may include a display, a processor, an operating system, a transient memory (e.g., RAM), an input device (e.g., mouse and keyboard), and a circuitry to provide communication paths between the components. The operating system may be Windows, OSX, Linux, iOS, Android, and the like.

As mentioned herein, the user device 102 may include the operating system such as Windows, OSX, Linux, iOS, Android, and the like. The operating system may include embedded functionality to shorten one or more URLs. The user device 102 may include the host application 106 such as a word processor, an email application, a browser, other document processing applications, other messaging applications, social media applications, ecommerce applications and the like. The host application 106 may communicate with information providers and users, who may exchange content items (e.g., web pages) in networked environments such as the Internet. The user may communicate with the web pages through URLs or links that may specify where a known resource is located in the communication network 104. The functionality to shorten the one or more URL may be embedded in the operating system. The user may install the plug-in on the host application 106 to shorten the one or more URLs. The process of shortening the one or more URLs will be explained with the help of the subsequent figures.

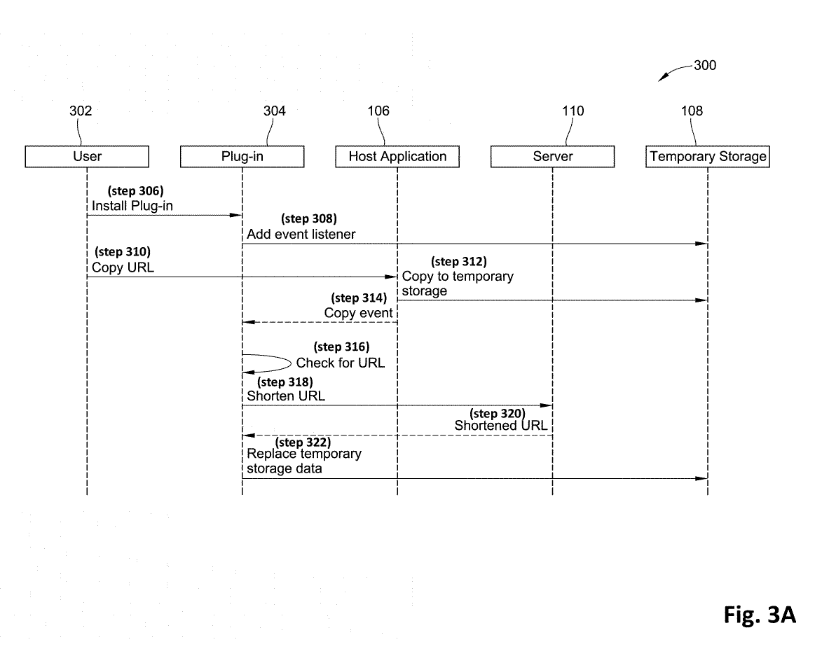

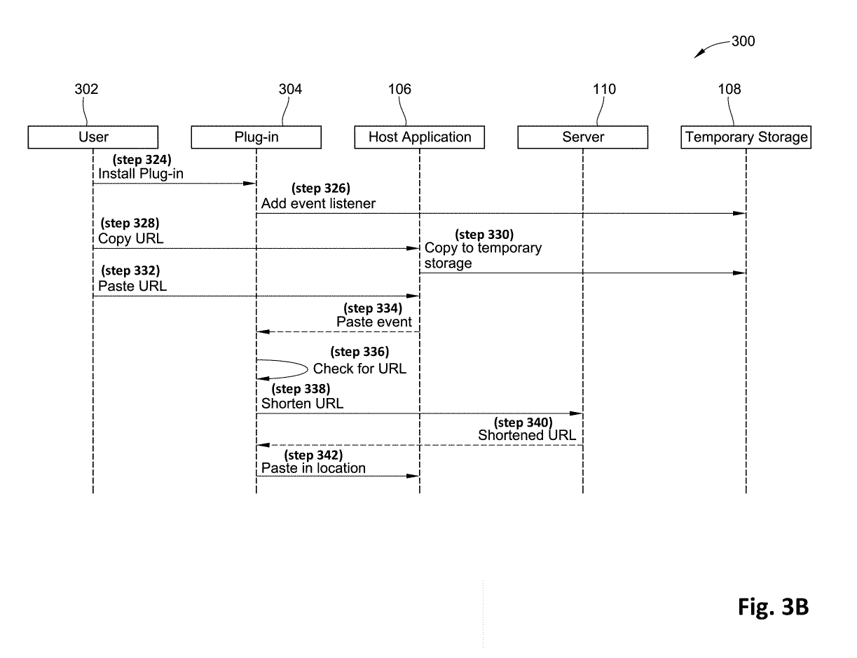

FIG. 3A illustrates a sequence diagram 300 depicting a URL shortening mechanism using a copy command according to an embodiment of the invention. FIGS. 3A and 3B will be described in conjunction with FIG. 1. In this embodiment, a user 302 may install a plug-in 304 at step 306 on the host application 106 of the user device 102. When the host application 106 is active, the plug-in 304 may add the event listener to the temporary storage location 108 associated with the host application 106 at step 308. In an example, the user 302 may initiate the copy command at step 310 to copy selected content from the host application 106. The copy command may be initiated by the user 302 by performing an action such as a Ctrl+C action, a right click and select copy action, a menu-based copy action, and any other copy action; for example, any action that may invoke the operating system to copy the selected content from the host application 106 to the temporary storage location 108 at step 312. Upon receiving the command from the user 302, the host application 106 may initiate a copy event at step 314 to be sent to the plug-in and may provide the selected content to the temporary storage location 108. The selected content may include one or more URLs along with other data such as text, images, and the like to the temporary storage 108 location.

In response to receiving the copy event, the plug-in 304 may automatically initiate the event listener to parse the selected content of the temporary storage location 108 and identify the one or more URLs at step 316. The identification of the one or more URLs may be performed based on a protocol scheme. For example, the event listener may parse the portion of contents and identify the one or more URLs that may start with the protocol scheme such as ‘http://’, ‘https://’, ftp, and any other protocol scheme understood by a browser. On identifying the one or more URLs, the event listener may trigger the plug-in 304 to invoke a call such as an Asynchronous JavaScript and XML (AJAX) call to the first server 110 for shortening the one or more selected URLs at steps 318.

Optionally, the first server 110 may send a request to the second server 112 to affiliate the one or more of the selected URLs with the one or more merchant sites, upon determining that the affiliation code required for affiliating the one or more selected URLs with one or more merchant sites is available, before shortening the one or more URLs. The first server 110 may include URL shortening APIs to shorten the one or more selected URLs. The URL shortening APIs may convert the one or more selected URLs to the one or more shortened URLs. The first server 110 may use one or more domains such as mydomain.com or anydomain.com to auto-shorten the one or more selected URLs.

For example, in an embodiment where the first server 110 uses mydomain.com as the domain to shorten the one or more URLs such as http://www.originallongURL.com, the converted one or more shortened URLs may be http://mydomain.com/shortURL. In another embodiment, where the first server 110 uses anydomain.com as the domain to shorten the one or more URLs such as http://www.originallongURL.com, the converted one or more shortened URLs may be http://anydomain.com/shortURL.

The first server 110 may then return the one or more shortened URLs to the plug-in at step 320 and may replace the contents of the temporary storage location 108 at step 322.

The invention may not prevent the user from copying text, images or other data to the temporary storage location 108, but the one or more selected URLs present in the temporary storage location 108 may only get shortened. Further, the shortening of the one or more selected URLs as described by the sequence diagram 300 may apply to all cases where the copy command may be initiated via the Ctl+C action, the right click copy action, the menu-based copy action, and any other action invoking the operating system to copy the selected content to the temporary storage location 108. All these actions may cause the above sequence of steps to be executed.

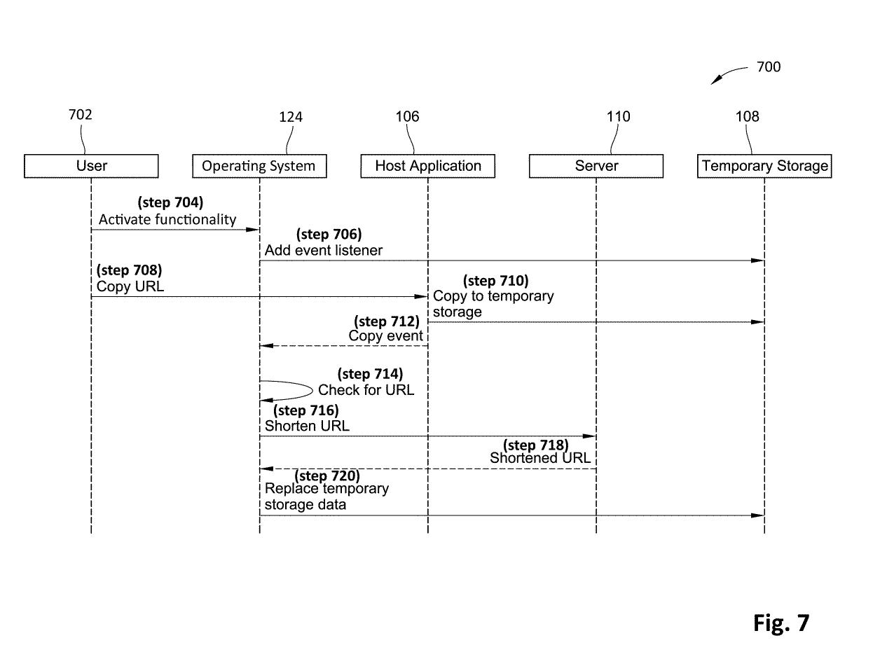

FIG. 7 illustrates a sequence diagram 700 depicting a URL shortening mechanism using a copy command according to an embodiment of the invention. FIGS. 7 will be described in conjunction with FIG. 1. In this embodiment, a user 702 may use the user device 102 with URL shortening functionality embedded in the operating system 124 of the user device 102. When auto-shortening functionality of the user device 102 is activated at step 704 the operating system 124 may add the event listener at step 706 to the temporary storage location 108 associated with the host application 106. In an example, the user 702 may initiate the copy command to copy selected content at step 708 from a host application 106. The copy command may be initiated by the user 702 by performing an action such as a Ctrl+C action, a right click and select copy action, a menu-based copy action, and any other copy action; for example, any action that may invoke the operating system to copy the selected content from the host application 106 to the temporary storage location 108. Upon receiving the command from the user 702, the host application 106 may initiate a copy event at step 710 to be sent to the operating system 124 and may provide the selected content to the temporary storage location 108. The selected content may include one or more URLs along with other data such as text, images, and the like to the temporary storage 108 location. In other non-limiting and exemplary embodiments, the copy command sequence may be replaced by the operating system passing a shortened URL as an argument to an application upon launch, after the operating system detects that an argument to be passed to an application upon launch includes a URL that has not been shortened, and then shortens the URL, before passing the shortened URL as an argument to the application being launched.

In response to receiving the copy event at step 712, the operating system 124 may automatically initiate the event listener to parse the selected content of the temporary storage location 108 and identify the one or more URLs at step 714. The identification of the one or more URLs may be performed based on a protocol scheme. For example, the event listener may parse the portion of contents and identify the one or more URLs that may start with the protocol scheme such as ‘http://’, ‘https://’, ftp, and any other protocol scheme understood by a browser. On identifying the one or more URLs, the event listener may trigger the plug-in 304 to invoke a call such as an Asynchronous JavaScript and XML (AJAX) call to the first server 110 for shortening the one or more selected URLs.

Optionally, the first server 110 may send a request to the second server 112 to affiliate the one or more of the selected URLs with the one or more merchant sites, upon determining that the affiliation code required for affiliating the one or more selected URLs with one or more merchant sites is available, before shortening the one or more URLs. The first server 110 may include URL shortening APIs to shorten the one or more selected URLs. The URL shortening APIs may convert the one or more selected URLs to the one or more shortened URLs at step 716. The first server 110 may use one or more domains such as mydomain.com or anydomain.com to auto-shorten the one or more selected URLs.

For example, in an embodiment where the first server 110 uses mydomain.com as the domain to shorten the one or more URLs such as http://www.originallongURL.com, the converted one or more shortened URLs may be http://mydomain.com/shortURL. In another embodiment, where the first server 110 uses anydomain.com as the domain to shorten the one or more URLs such as http://www.originallongURL.com, the converted one or more shortened URLs may be http://anydomain.com/shortURL.

The first server 110 may then return the one or more shortened URLs to the plug-in at step 718 and may replace the contents of the temporary storage location 108 at step 720.

The invention may not prevent the user from copying text, images or other data to the temporary storage location 108, but the one or more selected URLs present in the temporary storage location 108 may only get shortened. Further, the shortening of the one or more selected URLs as described by the sequence diagram 300 may apply to all cases where the copy command may be initiated via the Ctl+C action, the right click copy action, the menu-based copy action, and any other action invoking the operating system to copy the selected content to the temporary storage location 108. All these actions may cause the above sequence of steps to be executed.

FIG. 3B illustrates a sequence diagram depicting a URL shortening mechanism using a paste command according to another embodiment of the invention. In this embodiment, the user 302 may install the plug-in 304 at step 324 on the host application 106 of the user device 102. When the host application 106 is active, the plug-in 304 may add the event listener at step 326 to the temporary storage location 108 associated with the host application 106. In an example, the user 302 may initiate a copy command at step 328 to copy selected content from the host application 106. Upon receiving the command from the user 302, the host application 106 may copy the selected content at step 330 to the temporary storage location 108. The selected content may include one or more URLs along with other data such as text, images, and the like to the temporary storage location 108. The one or more URLs present in the selected content may remain in the original or un-shortened form while being copied by the user 302.

Further, the user 302 may initiate a paste command at step 332 to the host application 106 for pasting the portion of contents from the temporary storage location 108. The paste command may be initiated by the user 302 by performing an action such as Ctrl+V action, a right click and select paste action, a menu-based paste action, and any other paste action; for example, any action that may invoke the operating system to paste the portion of contents from the temporary storage location 108. In other non-limiting and exemplary embodiments, the paste command sequence may be replaced by the operating system passing a shortened URL as an argument to an application upon launch, after the operating system detects that an argument to be passed to an application upon launch includes a URL that has not been shortened, and then shortens the URL, before passing the shortened URL as an argument to the application being launched.

At this point, the host application 106 may receive a paste event at step 334 from the plug-in 304 to paste the one or more URLs from the temporary storage location 108. In response to receiving the paste event, the plug-in 304 may initiate the event listener to parse the portion of contents of the temporary storage location 108 and identify the one or more URLs at step 336. The identification of the one or more URLs may be carried out on the basis of a protocol scheme. For example, the event listener may parse the portion of contents and identify the one or more URLs that may start with the protocol scheme such as ‘http://’ or ‘https://’ ‘ftp://’, and any other protocol scheme understood by the browser.

On identifying the one or more URLs, the event listener may trigger the plug-in 304 to invoke a call to the first server 110 for shortening the one or more selected URLs at step 338. Optionally, the first server 110 may send a request to the second server 112 to affiliate the one or more selected URLs with the one or more merchant sites, upon determining that the affiliation code required for affiliating the one or more selected URLs with one or more merchant sites is available, before shortening the one or more selected URLs. The first server 110 may include URL shortening APIs to shorten the one or more selected URLs. The URL shortening APIs may convert the one or more affiliated URLs to the one or more shortened URLs. The first server 110 may use one or more domains such as mydomain.com or anyotherdomain.com to auto-shorten the one or more URLs.

For example, in an embodiment where the first server 110 uses mydomain.com as the domain to shorten the one or more selected URLs such as http://www.originallongURL.com, the converted one or more shortened URLs may be http://mydomain.com/shortURL. In another embodiment, where the first server 110 uses anydomain.com as the domain to shorten the one or more selected URLs such as http://www.originallongURL.com, the converted one or more shortened URLs may be http://anydomain.com/shortURL.

The first server 110 may then return the one or more shortened URLs at step 340 to the plug-in, where the plug-in may paste the selected contents including the one or more shortened URLs to the host application 106. In an embodiment, the user 302 may paste the one or more shortened URLs at step 342 inside or outside the context of the host application 106, such as in a web form, a browser email window, an address bar, an e-mail, a word document, a custom mail program, and the like.

The invention may not prevent the user from pasting text, images or other data from the temporary storage location 108, but the one or more URLs present on the temporary storage 108 may only get shortened. Further, shortening of the one or more URLs, as described by the sequence diagram 300, may apply to all cases where the paste command may be initiated via the Ctl+V action, the right click paste action, the menu-based paste action, and any other action invoking the operating system to paste the portion of contents from the temporary storage location 108. All these actions may cause the above sequence of steps to be executed.

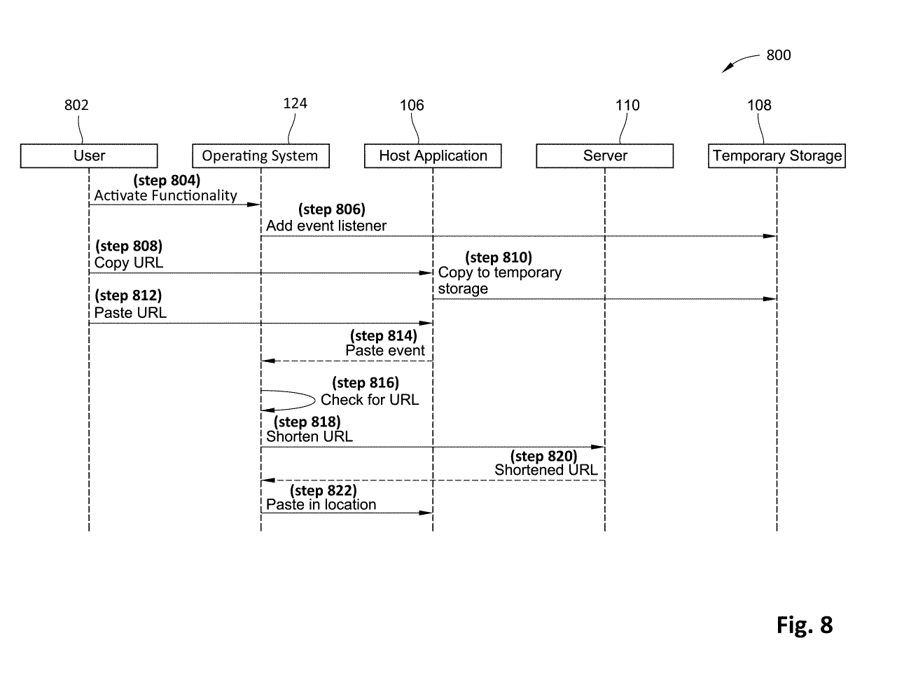

FIG. 8 illustrates a sequence diagram 800 depicting a URL shortening mechanism using a copy command according to an embodiment of the invention. FIG. 8 will be described in conjunction with FIG. 1. In this embodiment, a user 802 may use the user device 102 with URL shortening functionality embedded in the operating system 124. When auto-shortening functionality of the user device 102 is activated at step 804, the operating system 124 may add the event listener to the temporary storage location 108 at step 806 associated with the host application 106. In an example, the user 802 may initiate a copy command at step 808 to copy selected content from the host application 106. Upon receiving the command from the user 302, the host application 106 may copy the selected content to the temporary storage location 108 at step 810. The selected content may include one or more URLs along with other data such as text, images, and the like to the temporary storage location 108. The one or more URLs present in the selected content may remain in the original or un-shortened form while being copied by the user 802. In other non-limiting and exemplary embodiments, the copy command sequence may be replaced by the operating system passing a shortened URL as an argument to an application upon launch, after the operating system detects that an argument to be passed to an application upon launch includes a URL that has not been shortened, and then shortens the URL, before passing the shortened URL as an argument to the application being launched.

Further, the user 802 may initiate a paste command at step 812 to the host application 106 for pasting the portion of contents from the temporary storage location 108. The paste command may be initiated by the user 302 by performing an action such as Ctrl+V action, a right click and select paste action, a menu-based paste action, and any other paste action; for example, any action that may invoke the operating system to paste the portion of contents from the temporary storage location 108. In other non-limiting and exemplary embodiments, the paste command sequence may be replaced by the operating system passing a shortened URL as an argument to an application upon launch, after the operating system detects that an argument to be passed to an application upon launch includes a URL that has not been shortened, and then shortens the URL, before passing the shortened URL as an argument to the application being launched.

At this point, the host application 106 may receive a paste event at step 814 from the operating system 124 to paste the one or more URLs from the temporary storage location 108. In response to receiving the paste event, the operating system 124 may initiate the event listener to parse the portion of contents of the temporary storage location 108 and identify the one or more URLs at step 816. The identification of the one or more URLs may be carried out on the basis of a protocol scheme. For example, the event listener may parse the portion of contents and identify the one or more URLs that may start with the protocol scheme such as ‘http://’ or ‘https://’ ‘ftp://’, and any other protocol scheme understood by the browser.

On identifying the one or more URLs, the event listener may trigger the operating system 124 to invoke a call to the first server 110 for shortening the one or more selected URLs at step 818. Optionally, the first server 110 may send a request to the second server 112 to affiliate the one or more selected URLs with the one or more merchant sites, upon determining that the affiliation code required for affiliating the one or more selected URLs with one or more merchant sites is available, before shortening the one or more selected URLs. The first server 110 may include URL shortening APIs to shorten the one or more selected URLs. The URL shortening APIs may convert the one or more affiliated URLs to the one or more shortened URLs. The first server 110 may use one or more domains such as mydomain.com or anyotherdomain.com to auto-shorten the one or more URLs.

For example, in an embodiment where the first server 110 uses mydomain.com as the domain to shorten the one or more selected URLs such as http://www.originallongURL.com, the converted one or more shortened URLs may be http://mydomain.com/shortURL. In another embodiment, where the first server 110 uses anydomain.com as the domain to shorten the one or more selected URLs such as http://www.originallongURL.com, the converted one or more shortened URLs may be http://anydomain.com/shortURL.

The first server 110 may then return the one or more shortened URLs to the plug-in at step 820, where the plug-in may paste the selected contents including the one or more shortened URLs to the host application 106. In an embodiment, the user 302 may paste the one or more shortened URLs at step 822 inside or outside the context of the host application 106, such as in a web form, a browser email window, an address bar, an e-mail, a word document, a custom mail program, and the like.

The invention may not prevent the user from pasting text, images or other data from the temporary storage location 108, but the one or more URLs present on the temporary storage 108 may only get shortened. Further, shortening of the one or more URLs, as described by the sequence diagram 800, may apply to all cases where the paste command may be initiated via the Ctl+V action, the right click paste action, the menu-based paste action, and any other action invoking the operating system to paste the portion of contents from the temporary storage location 108. All these actions may cause the above sequence of steps to be executed.

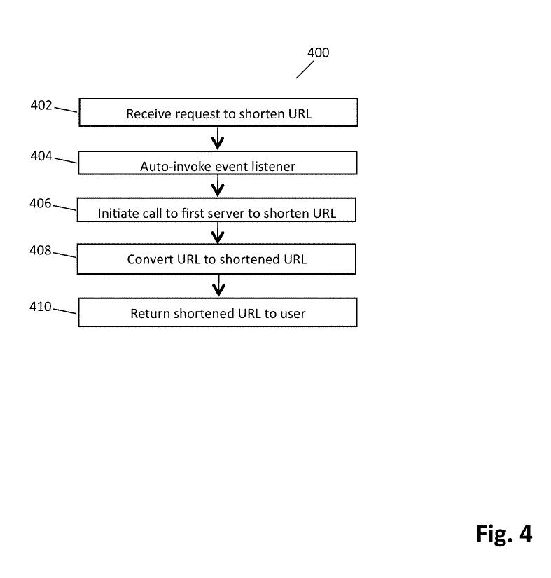

FIG. 4 illustrates generally, by way of example, but not by way of limitation, an example of a method 400 for automatically shortening URLs via a plug-in. FIG. 4 also provides an overview of the operation of various novel features of the invention. In the flow charts, various algorithmic steps are summarized in individual “blocks”. Some of the steps are performed by a user of the plug-in and others by one or more servers. The method 400 is in accordance with the elements described in FIGS. 1 and 2. The method 400 may allow the user to initiate a command to the temporary storage location 108. In embodiments, the command may be a copy or a paste command. This method 400 of automatically shortening the URLs by using the copy and paste commands may apply to all cases where the copy command may be initiated via the Ctl+C action, the right click copy action, the menu-based copy action, and any other action invoking the operating system to copy the portion of contents on the temporary storage 108; and the paste command may be initiated via the Ctl+V action, the right click paste action, the menu-based paste action, and any other action invoking the operating system to paste the portion of contents from the temporary storage 108. All these actions may cause the following sequence of steps to be executed.

In the method 400, selected content may be received by the temporary storage location 108 upon initiation of the command by the user. The selected content may include one or more URLs. It will be evident to a person skilled in the art that the selected content may also include data such as text, images and the like in addition to the one or more selected URLs. At step 402, a request may be received to shorten the one or more selected URLs upon initiation of the command from the user. The request may be received automatically, i.e., the user may not be required to click on the plug-in to shorten the one or more selected URLs. Further, at step 404, the event listener may be invoked automatically to parse the selected contents of the temporary storage location 108 and identify the one or more URLs based on a protocol scheme. Upon identification of the one or more selected URLs, the event listener may trigger the plug-in to initiate a call to the first server 110 for shortening the one or more URLs as shown in step 406. At step 408, the first server 110 may then shorten the one or more selected URLs to the one or more shortened URLs using any domain. At step 410, the contents of the temporary storage location 108 of the user may be replaced with the one or more shortened URLs and return the one or more shortened URLs to the user.

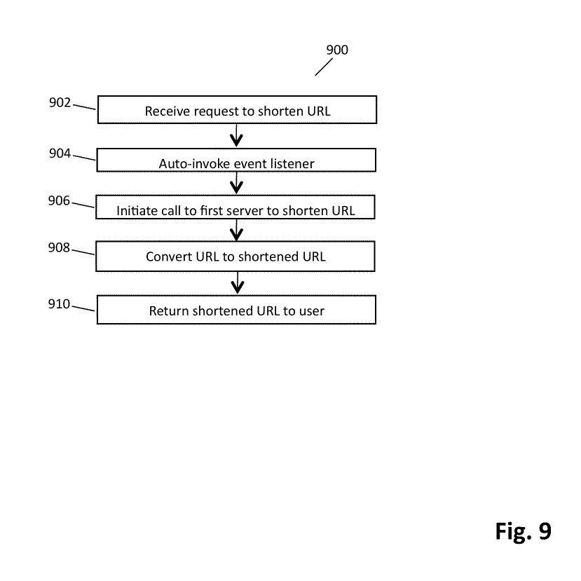

FIG. 9 illustrates generally, by way of example, but not by way of limitation, an example of a method 900 for automatically shortening URLs via a functionality embedded in an operating system. FIG. 9 also provides an overview of the operation of various novel features of the invention. In the flow charts, various algorithmic steps are summarized in individual “blocks”. Some of the steps are performed by a user of the plug-in and others by one or more servers. The method 900 is in accordance with the elements described in FIGS. 1 and 2. The method 900 may allow the user to initiate a command to the temporary storage location 108. In embodiments, the command may be a copy or a paste command. This method 900 of automatically shortening the URLs by using the copy and paste commands may apply to all cases where the copy command may be initiated via the Ctl+C action, the right click copy action, the menu-based copy action, and any other action invoking the operating system to copy the portion of contents on the temporary storage 108; and the paste command may be initiated via the Ctl+V action, the right click paste action, the menu-based paste action, and any other action invoking the operating system to paste the portion of contents from the temporary storage 108. In other non-limiting and exemplary embodiments, the copy and paste command sequences may be replaced by the operating system passing a shortened URL as an argument to an application upon launch, after the operating system detects that an argument to be passed to an application upon launch includes a URL that has not been shortened, and then shortens the URL, before passing the shortened URL as an argument to the application being launched. All these actions may cause the following sequence of steps to be executed.

In the method 900, selected content may be received by the temporary storage location 108 upon initiation of the command by the user. The selected content may include one or more URLs. It will be evident to a person skilled in the art that the selected content may also include data such as text, images and the like in addition to the one or more selected URLs. At step 902, a request may be received to shorten the one or more selected URLs upon initiation of the command from the user. The request may be received automatically, i.e., the user may not be required to click on the plug-in to shorten the one or more selected URLs. Further, at step 904, the event listener may be invoked automatically to parse the selected contents of the temporary storage location 108 and identify the one or more URLs based on a protocol scheme. Upon identification of the one or more selected URLs, the event listener may trigger the plug-in to initiate a call to the first server 110 for shortening the one or more URLs as shown in step 906. At step 408, the first server 110 may then shorten the one or more selected URLs to the one or more shortened URLs using any domain. At step 910, the contents of the temporary storage location 108 of the user may be replaced with the one or more shortened URLs and return the one or more shortened URLs to the user.

In an embodiment, optionally, the first server 110 may send a request to the second server 112 to affiliate the one or more selected URLs with the one or more merchant sites, upon determining that the affiliation code required for affiliating the one or more selected URLs with one or more merchant sites is available, before shortening the one or more selected URLs. The second server 112 may include a tracking mechanism that may be configured to affiliate the one or more selected URLs with the one or more merchant sites and may send the one or more affiliated URLs to the first server 110 so that one or more merchants may credit revenue to the first server 110 whenever one or more Internet users purchase a product or service from the merchant sites.

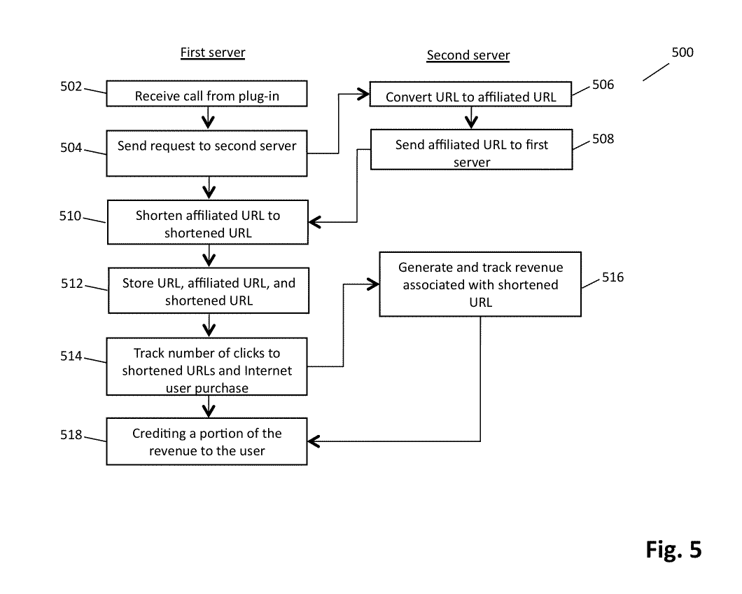

FIG. 5 illustrates a flowchart depicting a method 500 for affiliating the one or more URLs according to an embodiment of the present invention. The method 500 is in accordance with the elements described in FIGS. 1 and 2. The method 500 may include the first server 110 for shortening the one or more selected URLs and tracking the one or more shortened URLs and/or the second server 112 for affiliating the one or more selected URLs and tracking revenue generated by the one or more shortened URLs. At step 502, the first server 110 may receive a call from the plug-in to shorten the one or more selected URLs. At step 504, the first server 110 may request the second server 112 to affiliate the one or more selected URLs with the one or more merchant sites upon determining that the affiliation code required for affiliating the one or more selected URLs with one or more merchant sites is available. The second server 112 may be a third-party server, which may leverage a tracking mechanism for affiliating the one or more selected URLs with the one or more merchant sites and track the revenue generated by the one or more shortened URLs. At step 506, the second server 112 may affiliate the one or more selected URLs with the one or more merchant sites by adding parameters such as affiliation code that may uniquely identify the one or more selected URLs.

In an embodiment, if two different users request to affiliate the same URL, the method 500 may allow the second server 112 to provide two different affiliated URLs to the first server 110. The second server 112 may distinguish the two URLs by adding additional parameters that may facilitate separate tracking of any purchase made via each of the two different affiliated URLs.

At steps 508 and 510, the first server 110 may shorten the one or more affiliated URLs to the one or more shortened URLs; the one or more affiliated URLs may be provided by the second server 112 to the first server 110. The first server 110 may include URL shortening APIs that may shorten the one or more affiliated URLs to the one or more shortened URLs using one or more domains. At step 512, the first server 110 may store the one or more selected URLs, the one or more affiliated URLs, and the one or more shortened URLs in the database 114. The method 500 may facilitate users to share the one or more shortened URLs with the other Internet users 116-122 via an email, a word document, a custom mail program, a webpage, and the like, such that the Internet users 116-122 may click and access the one or more shortened URLs. The one or more shortened URLs may navigate the Internet user browser window to a merchant site where the Internet users 116-122 may purchase any service or product. At step 514, the first server 110 may track the number of clicks made to the one or more shortened URLs and associate the number of clicks with a user account. At step 516, the second server 112 may generate revenue, whenever the one or more Internet users purchase the product or service. The second server 112 may also track the revenue generated by the one or more shortened URLs and may report the revenue to the first server 110 on a regular basis such as daily, weekly, monthly, and the like for each affiliated URL. The method 500 may also include a step 518 for crediting a portion of revenue to the user, who has requested to shorten the one or more URLs. This step of sharing or crediting the portion of generated revenue may be calculated as per a set commission scheme.

In an embodiment, the method 500 may also allow the first server 110 to track the number of clicks associated with the one more shortened URLs even if the user undoes the one or more shortened URLs and shares them with other Internet users. At this step, the second server 112 may still affiliate the one or more selected URLs with the one or more merchant sites to provide the user with the one or more affiliated URLs. As already described, the first server 110 may store the one or more selected URLs, one or more affiliated URLs, and the one or more shortened URLs in the database 114. The database 114 may provide the first server 110 with enough information to track the one or more selected URLs requested for shortening even if they are undone by the user.

In an example, even if the user undoes a shortened URL, the user may still be provided with an affiliated URL such that the first server 110 may track the number of clicks associated with the affiliated URL and associate it with the user account. Further, the second server 112 may generate revenue whenever an Internet user purchases a product or service through the affiliated URL. The second server 112 may report the revenue to the first server 110 such that a portion of the revenue may be credited to the user. This step of sharing or crediting the portion of generated revenue may be calculated based on a set commission scheme.

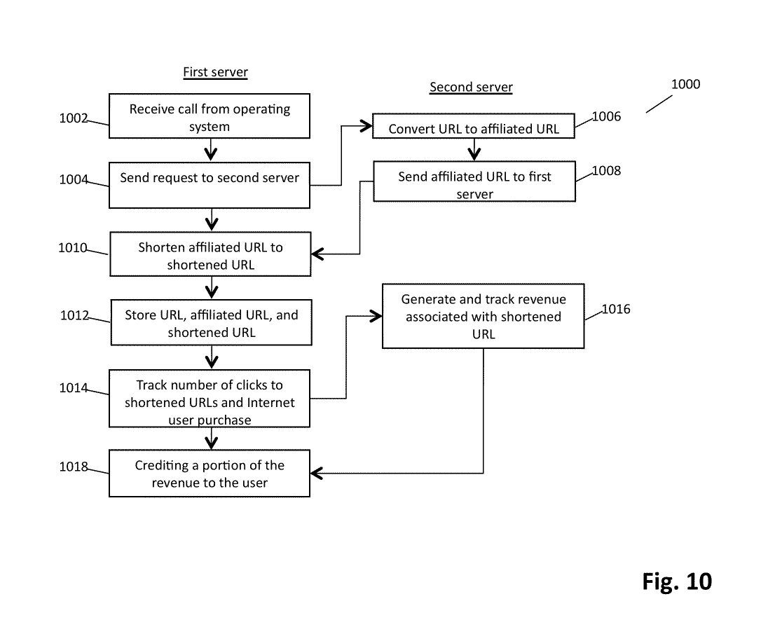

FIG. 10 illustrates a flowchart depicting a method 1000 for affiliating the one or more URLs according to an embodiment of the present invention. The method 1000 is in accordance with the elements described in FIGS. 1 and 2. The method 1000 may include the first server 110 for shortening the one or more selected URLs and tracking the one or more shortened URLs and/or the second server 112 for affiliating the one or more selected URLs and tracking revenue generated by the one or more shortened URLs. At step 1002, the first server 110 may receive a call from the operating system to shorten the one or more selected URLs. At step 1004, the first server 110 may request the second server 112 to affiliate the one or more selected URLs with the one or more merchant sites upon determining that the affiliation code required for affiliating the one or more selected URLs with one or more merchant sites is available. The second server 112 may be a third-party server, which may leverage a tracking mechanism for affiliating the one or more selected URLs with the one or more merchant sites and track the revenue generated by the one or more shortened URLs. At step 1006, the second server 112 may affiliate the one or more selected URLs with the one or more merchant sites by adding parameters such as affiliation code that may uniquely identify the one or more selected URLs.

In an embodiment, if two different users request to affiliate the same URL, the method 1000 may allow the second server 112 to provide two different affiliated URLs to the first server 110. The second server 112 may distinguish the two URLs by adding additional parameters that may facilitate separate tracking of any purchase made via each of the two different affiliated URLs.

At steps 1008 and 1010, the first server 110 may shorten the one or more affiliated URLs to the one or more shortened URLs; the one or more affiliated URLs may be provided by the second server 112 to the first server 110. The first server 110 may include URL shortening APIs that may shorten the one or more affiliated URLs to the one or more shortened URLs using one or more domains. At step 1012, the first server 110 may store the one or more selected URLs, the one or more affiliated URLs, and the one or more shortened URLs in the database 114. The method 1000 may facilitate users to share the one or more shortened URLs with the other Internet users 116-122 via an email, a word document, a custom mail program, a webpage, and the like, such that the Internet users 116-122 may click and access the one or more shortened URLs. The one or more shortened URLs may navigate the Internet user browser window to a merchant site where the Internet users 116-122 may purchase any service or product. At step 1014, the first server 110 may track the number of clicks made to the one or more shortened URLs and associate the number of clicks with a user account. At step 1016, the second server 112 may generate revenue, whenever the one or more Internet users purchase the product or service. The second server 112 may also track the revenue generated by the one or more shortened URLs and may report the revenue to the first server 110 on a regular basis such as daily, weekly, monthly, and the like for each affiliated URL. The method 1000 may also include a step 1018 for crediting a portion of revenue to the user, who has requested to shorten the one or more URLs. This step of sharing or crediting the portion of generated revenue may be calculated as per a set commission scheme.

In an embodiment, the method 1000 may also allow the first server 110 to track the number of clicks associated with the one more shortened URLs even if the user undoes the one or more shortened URLs and shares them with other Internet users. At this step, the second server 112 may still affiliate the one or more selected URLs with the one or more merchant sites to provide the user with the one or more affiliated URLs. As already described, the first server 110 may store the one or more selected URLs, one or more affiliated URLs, and the one or more shortened URLs in the database 114. The database 114 may provide the first server 110 with enough information to track the one or more selected URLs requested for shortening even if they are undone by the user.

In an example, even if the user undoes a shortened URL, the user may still be provided with an affiliated URL such that the first server 110 may track the number of clicks associated with the affiliated URL and associate it with the user account. Further, the second server 112 may generate revenue whenever an Internet user purchases a product or service through the affiliated URL. The second server 112 may report the revenue to the first server 110 such that a portion of the revenue may be credited to the user. This step of sharing or crediting the portion of generated revenue may be calculated based on a set commission scheme.

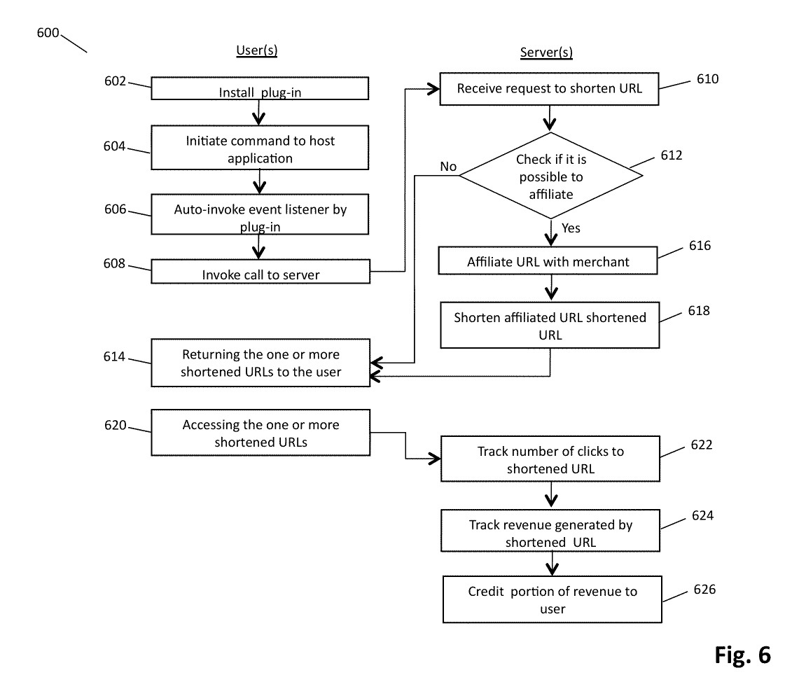

FIG. 6 illustrates a flowchart depicting a method 600 of communication between a user device 102 and a server according to embodiments of the present invention. The method 600 shown in FIG. 6 is in accordance with the elements described in FIGS. 1 and 2. At step 602, the user may download and install the plug-in. When the host application 106 is active the plug-in may attach the event listener to a temporary storage location 108 associated with the host application 106. At step 604, the user may initiate a command such as a copy command or a paste command to the host application 106 to copy or paste selected content from or to the temporary storage location 108. In other non-limiting and exemplary embodiments, the copy and paste commands may be replaced by the operating system passing a shortened URL as an argument to an application upon launch, after the operating system detects that an argument to be passed to an application upon launch includes a URL that has not been shortened, and then shortens the URL, before passing the shortened URL as an argument to the application being launched. Upon initiation of the command, the selected content including one or more URLs may be received by the temporary storage location 108 associated with the host application 106. The method 600 may not prevent the user from copying or pasting text, images, or other data from or to the temporary storage 108, but the one or more URLs that may be present on the temporary storage 108 may only get shortened. In response to receiving the command from the user at step 606, the method 600 may invoke the event listener to parse the contents of the temporary storage location 108 and identify the one or more selected URLs based on a protocol scheme.

Further, at steps 608 and 610, on identification of the one or more URLs, the event listener may trigger the plug-in to invoke a call to the first server 110 for shortening the one or more selected URLs. At step 612, the first server 110 determines whether affiliation codes to affiliate the one or more selected URLs with one or more merchants are available, such that the one or more merchants may credit the first server 110 with revenue whenever the one or more Internet users purchase a product or service via the one or more shortened URLs. In an embodiment, the first server 110 may include the link shortening APIs to shorten the one or more URLs to the one or more shortened URLs using one or more domains. The first server may shorten the one or more URLs upon determining that the affiliation code is not available for affiliating the one or more URLs with one or more merchants. At step 614, the first server 110 may return the one or more shortened URLs to the user for use.

In another embodiment, the first server 110 may request the second server 112 to affiliate the one or more URLs with the one or more merchant sites, upon determining that the affiliation code to affiliate the one or more URLs is available. At step 616, the second server 112 may affiliate the one or more URLs with the one or more merchant sites by adding parameters to the one or more URLs. At step 618, the first server 110 may shorten the one or more affiliated URLs to the one or more shortened URLs using one or more domains. The one or more affiliated URLs may be provided by the second server 112 to the first server 110 after the step of affiliation. At steps 614, the first server 110 may replace the contents of the temporary storage location 108 associated with the host application 106 by sending the one or more shortened URLs to the temporary storage location 108.

In yet another embodiment, at steps 620 and 622, the one or more Internet users 116-122 may click and access the one or more shortened URLs. The one or more URLs may navigate the Internet user browser window to a merchant site where the Internet users 116-122 may purchase or buy any service or product. The first server 110 may then track the number of clicks made to the one or more shortened URLs and associate it with the user account. At step 624, the second server 112 may generate revenue whenever the one or more Internet users purchase the product or service. Further, the second server 112 may track the revenue generated by the one or more shortened URLs and may report revenue numbers to the first server 110 on a regular basis. Furthermore, at step 626, the first server 110 may credit a portion of revenue to the user who created the request for shortening the one or more URLs. This step of sharing or crediting the portion of generated revenue may be calculated based on a set commission scheme.

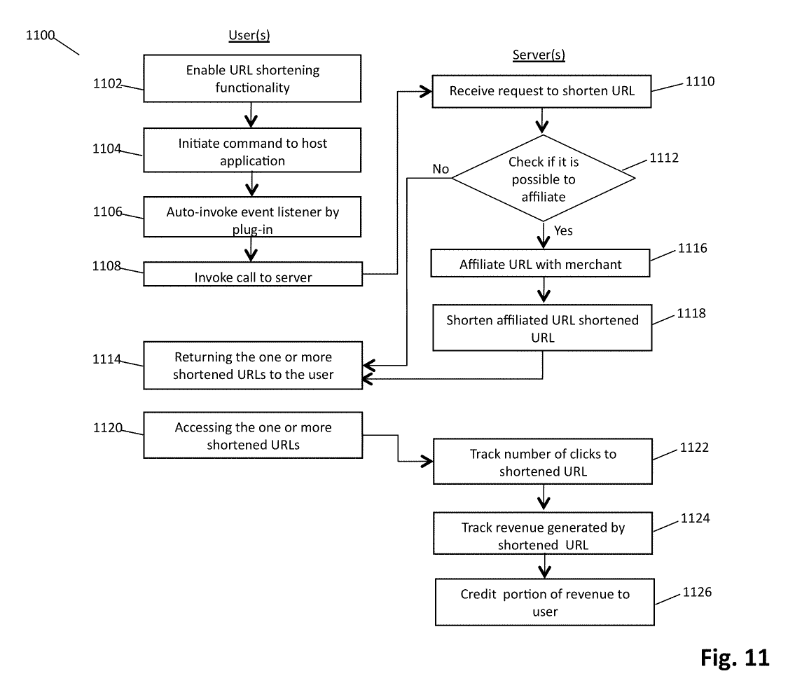

FIG. 11 illustrates a flowchart depicting a method 1100 of communication between a user device 102 and a server according to embodiments of the present invention. The method 1100 shown in FIG. 11 is in accordance with the elements described in FIGS. 1 and 2. When the embedded functionality 106 is active the operating system 124 may attach the event listener to a temporary storage location 108 associated with the host application 106. At step 1104, the user may initiate a command such as a copy command or a paste command to the host application 106 to copy or paste selected content from or to the temporary storage location 108. In other non-limiting and exemplary embodiments, the copy or paste commands may be replaced by the operating system passing a shortened URL as an argument to an application upon launch, after the operating system detects that an argument to be passed to an application upon launch includes a URL that has not been shortened, and then shortens the URL, before passing the shortened URL as an argument to the application being launched. Upon initiation of the command, the selected content including one or more URLs may be received by the temporary storage location 108 associated with the host application 106. The method 1100 may not prevent the user from copying or pasting text, images, or other data from or to the temporary storage 108, but the one or more URLs that may be present on the temporary storage 108 may only get shortened. In response to receiving the command from the user at step 1106, the method 1100 may invoke the event listener to parse the contents of the temporary storage location 108 and identify the one or more selected URLs based on a protocol scheme.

Further, at steps 1108 and 1110, on identification of the one or more URLs, the event listener may trigger the plug-in to invoke a call to the first server 110 for shortening the one or more selected URLs. At step 1112, the first server 110 determines whether affiliation codes to affiliate the one or more selected URLs with one or more merchants are available, such that the one or more merchants may credit the first server 110 with revenue whenever the one or more Internet users purchase a product or service via the one or more shortened URLs. In an embodiment, the first server 110 may include the link shortening APIs to shorten the one or more URLs to the one or more shortened URLs using one or more domains. The first server may shorten the one or more URLs upon determining that the affiliation code is not available for affiliating the one or more URLs with one or more merchants. At step 1114, the first server 110 may return the one or more shortened URLs to the user for use.

In another embodiment, the first server 110 may request the second server 112 to affiliate the one or more URLs with the one or more merchant sites, upon determining that the affiliation code to affiliate the one or more URLs is available. At step 1116, the second server 112 may affiliate the one or more URLs with the one or more merchant sites by adding parameters to the one or more URLs. At step 1118, the first server 110 may shorten the one or more affiliated URLs to the one or more shortened URLs using one or more domains. The one or more affiliated URLs may be provided by the second server 112 to the first server 110 after the step of affiliation. At steps 1114, the first server 110 may replace the contents of the temporary storage location 108 associated with the host application 106 by sending the one or more shortened URLs to the temporary storage location 108.

In yet another embodiment, at steps 1120 and 1122, the one or more Internet users 116-122 may click and access the one or more shortened URLs. The one or more URLs may navigate the Internet user browser window to a merchant site where the Internet users 116-122 may purchase or buy any service or product. The first server 110 may then track the number of clicks made to the one or more shortened URLs and associate it with the user account. At step 1124, the second server 112 may generate revenue whenever the one or more Internet users purchase the product or service. Further, the second server 112 may track the revenue generated by the one or more shortened URLs and may report revenue numbers to the first server 110 on a regular basis. Furthermore, at step 1126, the first server 110 may credit a portion of revenue to the user who created the request for shortening the one or more URLs. This step of sharing or crediting the portion of generated revenue may be calculated based on a set commission scheme.

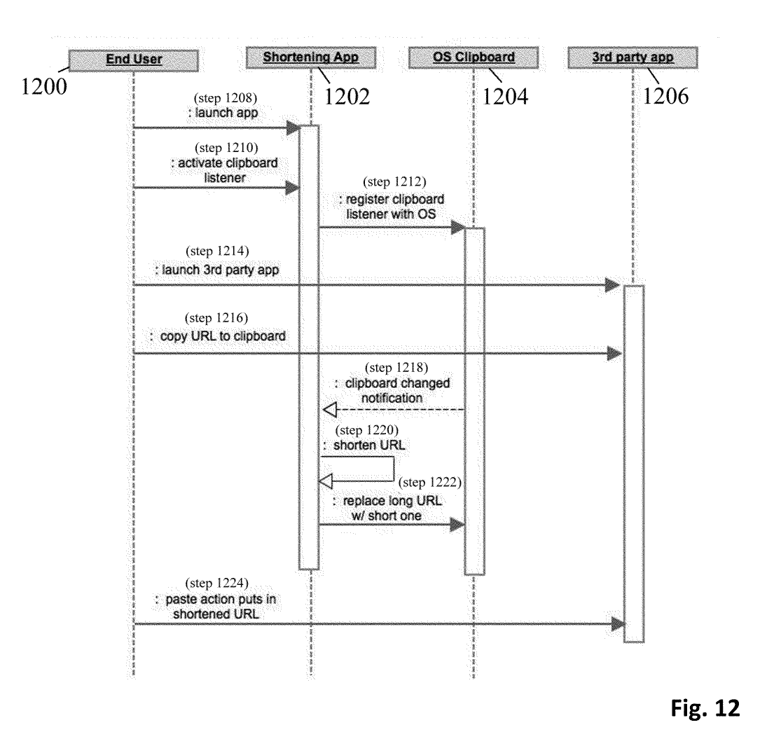

With reference to FIG. 12, there is illustrated an exemplary and non-limiting embodiment of a method for shortening URLs via a “plugin” type module. First, at step 1208, end user 1200 may launch a shortening application 1202 to turn on the shortening functionality. A shortening application 1212 could be an application which includes the functionality to shorten URLs where the primary purpose of the application is to shorten URLs, an application which includes the functionality to shorten URLs where the primary purpose of the application is not to shorten URLs, and the like. Next, at step 1210, the launch of the shortening application 1202 activates a clipboard listener by informing shortening application 1202 which in turn, at step 1212, registers the clipboard listener with the OS. This allows shortening application 1202 to function as a listener for change events. Then, at step 1214, while user 1200 leaves shortening application running in the background, user 1200 may launch a 3rd party application 1206. Then, from within the previously launched 3rd party application 1206, the user 1200 may initiate a copy action of a URL at step 1216. This copy action activates the listener registered in step 1212. Once activated, the listener, at step 1218, notifies the shortening application 1202 that clipboard has been changed. In response, at step 1202, the shortening application 1202 shortens the URL and then, at step 1222, replaces the long URL with the shortened URL in OS clipboard 1204. Lastly, at step 1224, a paste action, such as by user 1200 within 3rd party application 1206, results in pasting the contents of the OS clipboard 1204 comprising the shortened URL.

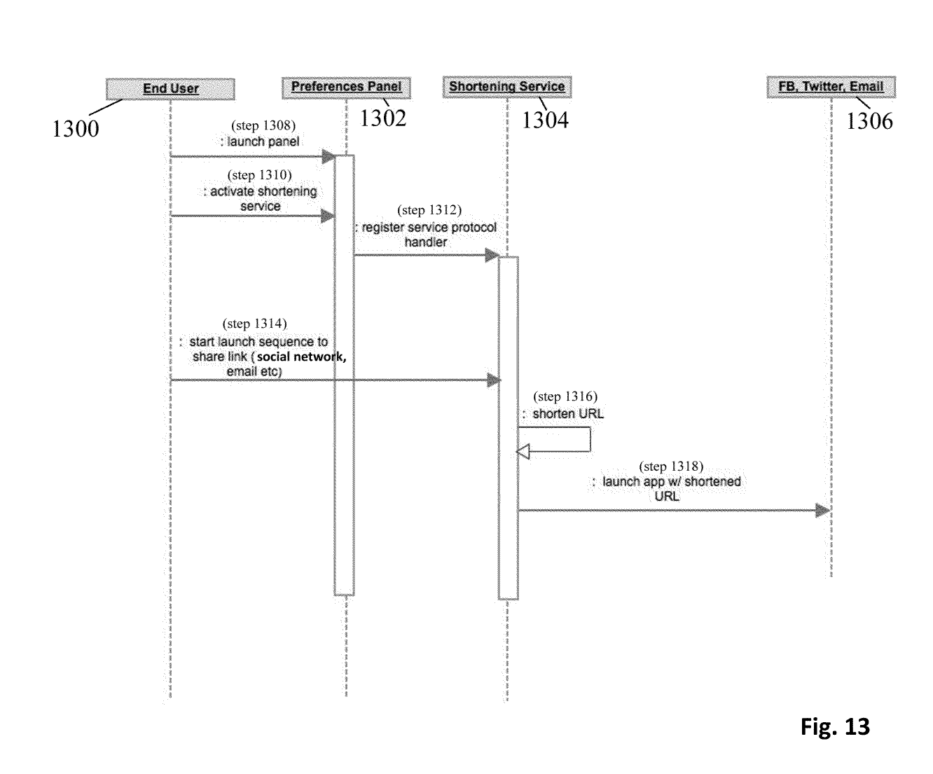

With reference to FIG. 13, there is illustrated an exemplary and non-limiting embodiment of a method for shortening URLs via a shortening service module 1304. First, at step 1308, user 1300 may launch preference panel 1302. Then, at step 1310, user 1300 may activate shortening service 804 via informing preferences panel 1302 which in turn, at step 1312, registers a service protocol handler with shortening service 1304. Next, at step 1314, user 1300 may start a launch sequence for an application from which they can share URLs such as, for example, a mobile browser. In other exemplary and non-limiting embodiments, the launch sequence for an application may be initiated upon registration of the service protocol handler with shortening service 1304. When user 1300 opens up a menu in the application, such as by highlighting the URL or by clicking on a button that lives within the application, the user 1300 may be provided a list of options of what to do with the URL. The list of options may include the ability to send the URL to a destination application 1306 including, but not limited to SMS, a social networking service such as Twitter or Facebook, and email. The user 1300 may then choose a destination application and the launch sequence is initiated for the destination application. Before the destination application 1306 is launched the OS intercepts the launch command, and invokes the OS shortening service 1304. Then, at step 1316, the OS shortening service 1304 attempts to shorten the URL. Once the URL is shortened, the OS continues the application launch sequence at step 1318 by replacing the original URL with the shortened URL. The destination application 1306 is then opened with the new shortened URL.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, cloud servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, cloud servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

The foregoing descriptions of specific embodiments of the present invention may be presented for the purposes of illustration and description. They may not be exhaustive or limit the invention to the precise forms disclosed. Obviously, many modifications and variations are possible in view of the above teachings. The embodiments were chosen and described to best explain the basic steps of the invention and its practical applications, thereby enabling others skilled in the art to best utilize the invention and various embodiments with various modifications as may be suited to the particular use. Furthermore, the order of steps, tasks or operations in the method may not necessarily intend to occur in the sequence laid out. It is intended that the scope of the invention is defined by the following claims and their equivalents.

All documents referenced herein are hereby incorporated by reference.

1. A method comprising:
receiving a request to shorten one or more URLs in response to a command initiated without clicking on a plug-in wherein a portion of the request is received in a temporary storage location;
automatically invoking an event listener to parse the portion in the temporary storage location, wherein the event listener facilitates identification of the one or more URLs based on a protocol scheme;
initiating a call to a first server, upon identification of the one or more URLs, for shortening the one or more URLs;
shortening the one or more URLs to one or more shortened URLs; and
returning the one or more shortened URLs to the user.

2. The method of claim 1, wherein the command is a copy command.

3. The method of claim 2, wherein the copy command can be invoked via any copy action initiated by the user.

4. The method of claim 1, wherein the command is a paste command.

5. The method of claim 4, wherein the paste command is invoked via any paste action initiated by the user.

6. The method of claim 1, wherein the method is executed in a mobile operating system environment, further comprising having the user launch a shortening application into which the user copies and pastes a URL in order to shorten it.

7. The method of claim 1, wherein shortening the one or more URLs comprises:
receiving a call from at least one of a shortening application, a browser and a plug-in to shorten the one or more URLs, wherein the call is received at the first server;
sending a request to a second server to affiliate the one or more URLs with one or more merchant sites, wherein the request is sent by the first server upon receiving the call from the plug-in, further wherein the one or more URLs are converted to one or more affiliated URLs, upon affiliating the one or more URLs with one or more merchant sites at the second server; and
receiving at the first server, the one or more affiliated URLs from the second server, wherein the first server is configured to shorten the one or more affiliated URLs to one or more shortened URLs.

8. The method of claim 6, wherein the first server stores the one or more URLs, the one or more affiliated URLs, and the one or more shortened URLs into a database.

9. The method of claim 6, wherein the second server includes a tracking mechanism to track revenue generated by one or more shortened URLs, wherein the revenue is generated upon a purchase made through one or more affiliated URLs.

10. The method of claim 1, further comprising allowing at least one Internet user to access the one or more shortened URLs, wherein the at least one Internet user clicks to access the one or more shortened URLs.

11. The method of claim 1, wherein the first server tracks the number of clicks to one or more shortened URLs and associates it with a user account.

11. The method of claim 1, further comprising crediting a portion of the revenue to the user, wherein the portion is calculated based on a set commission scheme.

13. A method for automatically shortening one or more Uniform Resource Locators (URLs), using any domain via a functionality embedded in an operating system, the method comprising:
receiving a request to shorten the one or more URLs, the request is made via a command initiated without clicking on the plug-in, further wherein a portion of contents is received in a temporary storage location upon initiation of the command;
automatically invoking an event listener to parse the portion of contents to the temporary storage location, wherein the event listener facilitates identification of the one or more URLs based on a protocol scheme;
initiating a call to a first server, upon identification of the one or more URLs, for shortening the one or more URLs;
shortening the one or more URLs to one or more shortened URLs; and
returning the one or more shortened URLs to the user.

14. The method of claim 13, wherein the command is a copy command.

15. The method of claim 14, wherein the copy command can be invoked via any copy action initiated by the user.

16. The method of claim 13, wherein the command is a paste command.

17. The method of claim 16, wherein the paste command is invoked via any paste action initiated by the user.

18. The method of claim 13, wherein the method is executed in a mobile operating system environment, further comprising having the user launch a shortening application into which the user copies and pastes a URL in order to shorten it.

19. The method of claim 13, wherein shortening the one or more URLs comprises:
receiving a call from at least one of a shortening application, a browser and a plug-in to shorten the one or more URLs, wherein the call is received at the first server;
sending a request to the second server to affiliate the one or more URLs with one or more merchant sites, wherein the request is sent by the first server upon receiving the call from the plug-in, further wherein the one or more URLs are converted to one or more affiliated URLs, upon affiliating the one or more URLs with one or more merchant sites at the second server;
receiving at the first server, the one or more affiliated URLs from the second server, wherein the first server is configured to shorten the one or more affiliated URLs to one or more shortened URLs.

20. The method of claim 19, wherein the first server stores the one or more URLs, the one or more affiliated URLs, and the one or more shortened URLs into a database.

21. The method of claim 19, wherein the second server includes a tracking mechanism to track revenue generated by one or more shortened URLs, wherein the revenue is generated upon a purchase made through one or more affiliated URLs.

22. The method of claim 13, further comprising allowing at least one Internet users to access the one or more shortened URLs, wherein the at least one Internet users click to access the one or more shortened URLs.

23. The method of claim 13, wherein the first server tracks the number of clicks to one or more shortened URLs and associates it with a user account.

24. The method of claim 13, further comprising crediting a portion of the revenue to the user, wherein the portion is calculated based on a set commission scheme.
